(19) United States
(12) Patent Application Publication
(10) Pub. No.: US 2011/0154242 A1
(43) Pub. Date: Jun. 23, 2011

(54) FLOW DIFFERENTIAL PRESSURE MODULE

(76) Inventors: Jed Babbington Stevens, Mission Viejo, CA (US); Gregory Scott Sprenger, Evergreen, CO (US)

(21) Appl. No.: 12/973,303

(22) Filed: Dec. 20, 2010

Related U.S. Application Data
(60) Provisional application No. 61/288,563, filed on Dec. 21, 2009.

(51) Int. Cl. G05D 7/06; G06F 3/048

(52) U.S. Cl. 715/771; 700/282

(57) ABSTRACT

A pressure module for a transient fluid includes a circuit board having a means for processing data, a flow meter input in data communication with the circuit board to receive a flow data representing at least a flow rate of the fluid, and a pressure sensor input in data communication with the circuit board to receive a pressure data representing at least a differential pressure of the fluid, wherein the circuit board processes data from at least one of the flow meter and the pressure sensor to calculate a corrected differential pressure.

### CROSS-REFERENCE TO RELATED APPLICATION

This application claims the benefit of U.S. Provisional Patent Application Ser. No. 61/288,563 filed on Dec. 21, 2009, hereby incorporated herein by reference in its entirety.

### FIELD OF THE INVENTION

The invention generally relates to instruments for monitoring fluids. More particularly, the invention is directed to a flow differential pressure module and a method for monitoring a transient fluid.

### BACKGROUND OF THE INVENTION

Performance of a filter in a fluid is a function of differential pressure across the filter cartridge and the fluid media itself. Typically, filters require replacement when the filter reaches a recommended change-out differential pressure. Differential pressure readings depend on a flow rate through the filter. In many cases, filters are operated below the maximum rated flow rate.

Specifically, a main function of a fluid filter is to remove contaminants from the fluid. The filter uses various mechanisms to accomplish contaminant removal. Usually, as the filter removes contaminants, a flow restriction rises (i.e. the differential pressure increases). After the differential pressure rises to a particular threshold, the contaminant removal effectiveness of the filter starts to degrade. At a predetermined differential pressure, dependent on filter and application, replacement of the filter is required.

However, since differential pressure is directly related to the flow of fluid through the filter, higher flow rates produce more flow restriction or differential pressure. Replacement of the filter is required at a certain differential pressure at the maximum rated flow for the fluid. In many cases, the flow rate of the fluid is below the maximum rated flow. In order to retain proper functionality, the filter must be replaced at the appropriate time. In order to achieve proper functionality at reduced flow rates, many filter suppliers and users “correct” the differential pressure with graphs, charts, and even calculating spreadsheets to maximum rated flow. In fact, the recent edition of ATA103, which covers operational requirements for operating aviation fueling equipment, requires operators to calculate corrected differential pressure routinely.

It would be desirable to have a fluid differential pressure module for measuring characteristics of a fluid and calculating pre-defined metrics such as a correct differential pressure in real-time.

### SUMMARY OF THE INVENTION

Concordant and consistent with the present invention, a fluid differential pressure module for measuring characteristics of a fluid and calculating pre-defined metrics such as a correct differential pressure in real-time, has surprisingly been discovered.

In one embodiment, a pressure module for a transient fluid comprises: a circuit board having a means for processing data; a flow meter input in data communication with the circuit board to receive a flow data representing at least a flow rate of the fluid; and a pressure sensor input in data communication with the circuit board to receive a pressure data representing at least a differential pressure of the fluid; wherein the circuit board processes data from at least one of the flow meter and the pressure sensor to calculate a corrected differential pressure.

In another embodiments, a monitoring system for a transient fluid comprises: a circuit board having a means for processing data; a flow meter in data communication with the circuit board to transmit data thereto, the data representing at least a flow rate of the fluid; and a pressure sensor in data communication with the circuit board to transmit data thereto, the data representing at least a differential pressure of the fluid; wherein the circuit board processes data from at least one of the flow meter and the pressure sensor to calculate a corrected differential pressure.

The invention also provides methods of monitoring a transient fluid.

One method comprises the steps of: receiving a flow data representing at least a flow rate of the fluid; receiving a pressure data representing at least a differential pressure of the fluid; determining a coefficient of flow rate; determining a coefficient of pressure; and calculating a corrected differential pressure based upon the flow data, the pressure data, the coefficient of flow rate, and the coefficient of pressure.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a top perspective view of a flow differential pressure module according to an embodiment of the present invention; and

FIG. 2 is a schematic diagram showing electrical connections of various components to the flow differential pressure module of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

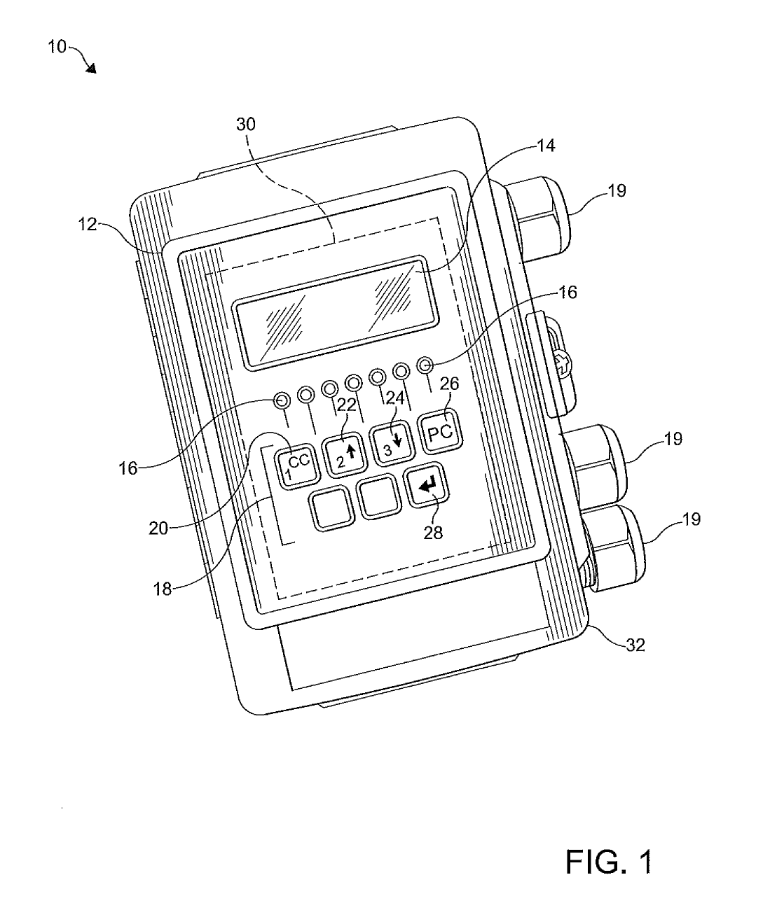

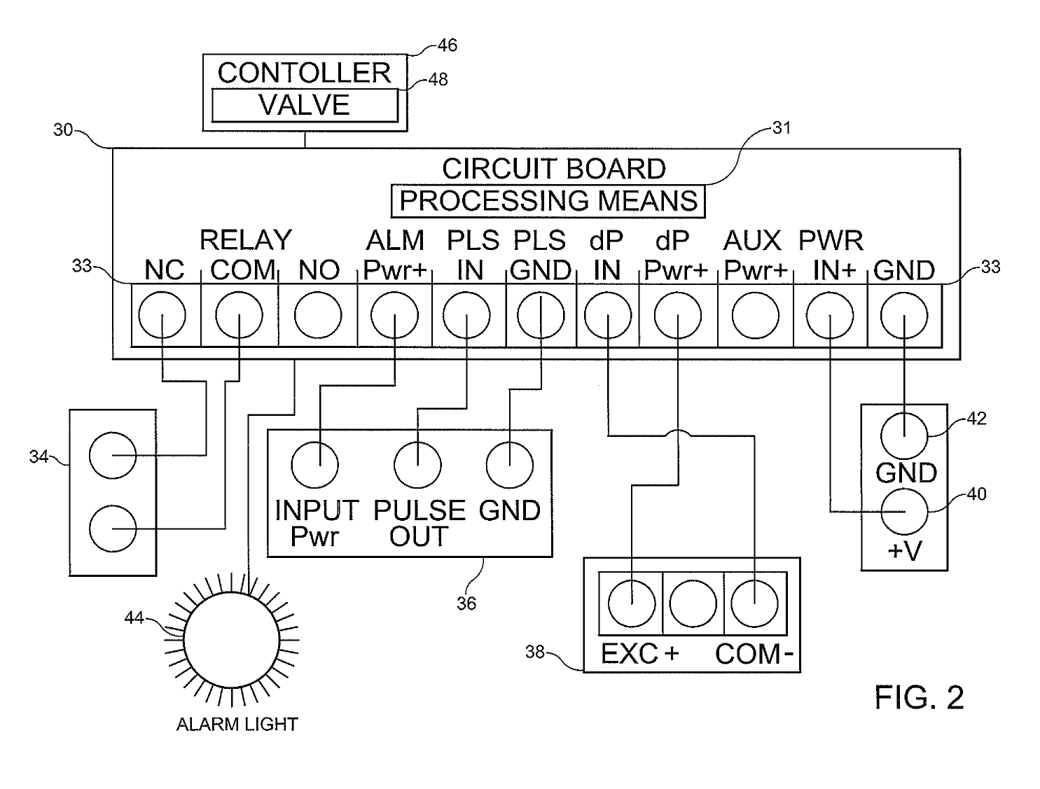

FIGS. 1-2 illustrate a flow differential pressure module 10 (FDPM) according to an embodiment of the present invention. The pressure module 10 is a computerized system designed to calculate a corrected differential pressure (corrected for flow and change-out differential pressure) of a filter vessel and determine if a filtering media inside the filter vessel has surpassed its useful life.

The pressure module 10 includes a user interface 12 having a display 14, a plurality of light emitting diodes (LEDs) 16, a keypad 18, and a plurality of input/output ports 19. It is understood that the user interface 12 may include any human-machine interface technology, as desired.

The display 14 is typically a liquid crystal display screen. However, any means of presenting a visual representation of a particular metric can be used. As a non-limiting example, the following metrics are presented on the display 14: a corrected differential pressure (Corr DP) (psid/bar); an actual differential pressure (Actual DP) (psid/bar); and a flow rate (gpm/lpm). It is understood that any metric or information may be displayed.

The light emitting diodes 16 are selectively illuminated to communicate a plurality of pre-determined alerts and signals to a user. It is understood that any light source having any color and intensity can be used. It is further understood that any number of light emitting diodes or light sources can be used.

The keypad 18 includes a plurality of user engageable buttons 20, 22, 24, 26, 28. For example, the “1\CC” button 20 is engaged from a default screen to select a change code menu. The “1\CC” button 20 is also used to enter the numeral “1” where numerical values are entered. The “2\Up” button 22 is engaged to either enter the numeral “2” where numerical values are entered, or to move the highlight bar up. The “3\Down” button 24 is engaged to either enter the numeral “3” where numerical values are entered, or to move the highlight bar down. The “PC” button 26 is engaged to select a pass code menu from the default screen. The “Enter” button 28 is engaged to enter a selection after highlighting or entering a numerical code. It is understood that the keypad 18 may include any number of buttons or switches for executing any number of programmable functions.

In certain embodiments, the input/output ports 19 include a flow meter input to receive a flow data representing at least a flow rate of the fluid. In certain embodiments, the input/output ports 19 include a pressure sensor input to receive a pressure data representing at least a differential pressure of the fluid. In certain embodiments, the input/output ports 19 can provide intercommunication with other control devices to receive a control signal from the pressure module 10. It is understood that the input/output ports 19 can be configured to provide intercommunication between the pressure module 10 and a variety of other components.

The pressure module 10 also includes a circuit board 30 having a processing means 31 for receiving a plurality of input signals representing at least one of a flow rate and a differential pressure measurement, and calculating at least a corrected differential pressure. Any means of transmitting data to the circuit board 30 can be used such as hard wire and wireless for example. As a non-limiting example, the input signals are routed through the input/output ports 19. As a further non-limiting example, the pressure module 10 includes a housing 32 for enclosing the circuit board 30, wherein the input/output ports 19 provide a selective access to the circuit board 30 through the housing 32.

As shown, the circuit board 30 includes a plurality of contact points 33 for electrically connecting the circuit board 30 to various electrical components such as a relay 34 (or deadman circuit), a flow meter 36 (i.e. flow pulser) for determining a flow rate of a fluid through a filter, a differential pressure transducer 38 (e.g. a model #8301025PD2F11B manufactured by Gems) for measuring a differential pressure through the filter, a power source 40, and a ground 42. As a non-limiting example, the circuit board 30 is a single board computer such as an LP3500 Single Board Computer manufactured by Rabbit. Additional components may be in electrical communication with the circuit board 30 such as an alarm light 44 for example. It is understood that any electrical configuration can be used, as desired. It is further understood that the circuit board 30 can include various processing components, storage components, and programmable components in order to facilitate the execution of software, firmware, and algorithms required to calculate any number of parameters.

In operation, a default main routine of the pressure module 10 monitors (via inputs to the circuit board 30) a flow rate of a filter vessel and the actual differential pressure (Actual DP) of the filter vessel and calculates a corrected differential pressure (Corr DP). As a non-limiting example, the corrected differential pressure is calculated based upon the following equation:

$$Corr DP = Actual DP \times [ ( A \times {e}^{( - B \times \% rated flow )} ) + ( C \times {e}^{( - D \times \% rated flow )} ) ]$$

### Wherein:

A, B, C, and D are variable parameters that can be supplied by a user, pre-programmed, or calculated by the processing means 31 of the circuit board 30; and
“% of rated flow” is in 0-100 scale based upon the measure flow rate and the maximum rated flow of the filter or device being measured.

It is understood that the actual differential pressure (can be measured in units of either psid or kPa. It is further understood that the variable parameters can be adjusted by a formula or algorithm to maximize accuracy. As a non-limiting example, favorable results have been achieved where A is approximately 2.237, B is approximately 0.0089, C is approximately 9.638, and D is approximately 0.0479. However, other values can be used for the variable parameters A, B, C, D.

During the main routine, the pressure module 10 displays the Corr DP (psid/bar), the Actual DP (psid/bar), and the flow rate (gpm/lpm). When a fluid flow is detected, the light emitting diodes 16 illuminate, which is an indication of flow. While flow is present, the pressure module 10 displays instantaneous values of the Corr DP, the Actual DP, and the flow rate. As a non-limiting example, during normal flow conditions, the light emitting diodes 16 will show green. However, any color can be used.

In certain embodiments, when there is no fluid flow detected, the pressure module 10 switches a display mode to show an average value of the Corr DP, the Actual DP, and the Flow Rate. The numbers presented on the display 14 are the average values for all of the time that fluid has been flowing. As a non-limiting example, in order to clear the averages and maximum values, the pressure module 10 can either be powered down (to off) or allowed to go into a sleep mode. During the no-flow condition, the light emitting diodes 16 are not illuminated and the user can view the maximum quality values for the metrics presented on the display 14.

In certain embodiments, if the Corr DP exceeds 80% of a predetermined threshold value (e.g. factory setting, user setting based on application) during fluid flow, the light emitting diodes 16 will change color to amber, which signifies a warning level. If the Corr DP exceeds the threshold value, the alarm mode is activated, which changes the color emitted by the light emitted diodes 16 to red and stops the flow of fluid. As a non-limiting example, the circuit board 30 is in communication with a controller 46 for controlling a valve 48 to manage a flow rate of the transient fluid. One skilled in the art of control valves can appreciate that various valves and controllers can be configured to receive a control signal from the circuit board 30 to manage the flow rate of the transient fluid.

In certain embodiments, the pressure module 10 activates an alarm mode and a shutdown of a fluid flow if the Corr DP exceeds a pre-determined alarm threshold (e.g. 15 or 25 psid, 1 or 1.7 bar.)

As a non-limiting example, in the case that the filter exceeds the corrected differential pressure the pressure module 10 will initiate the alarm sequence which will send a shutdown signal that can be tied to the relay 34, which will halt the flow of fluid. The alarm condition also changes the light emitting diodes 16 from Green (<80% Corr DP) to Yellow (80%<Corr DP<100%) to Red (>100% Corr DP.) When the alarm mode is initiated, the change-out code has to be entered to reset the pressure module 10 and allow the flow of fluid. Upon surpassing the alarm threshold for the Corr DP, the pressure module 10 will initiate a delay that will last for ten seconds per factory default (this can be changed in a passcode menu.) It is understood that the delay is to account for any transient pressure spikes that occur in the process of normal function of most fueling equipment. If the condition exists past the delay period, the pressure module 10 enters the alarm mode.

In a change code menu mode, the pressure module 10 provides a means for a user to modify certain parameters thereof. Specifically the change code menu allows a user to modify a rated flow for a particular filter and a threshold value for a differential pressure, indicating a filter change-out requirement.

A pass code menu presented on the display 14 of the pressure module 10 allows a user to modify at least one of a passcode, a flow meter coefficient, a pressure coefficient. A change passcode mode allows a user to designate a new three digit pass code. A new flow meter coefficient mode allows a user to enter a coefficient of flow rate so that the pressure module 10 represents the proper flow rate from the signal received from the flow meter 36. For example, the coefficient of flow rate can be adjusted based upon various types and configurations of the flow meter 36, as understood by one skilled in the art. A new pressure coefficient mode allows a user to enter a coefficient of pressure so that signal received from the pressure module 10 represents the proper pressure from a signal received from the pressure transducer 38. For example, the coefficient of pressure can be adjusted based upon various types and configurations of the flow meter 36, as understood by one skilled in the art. It is understood that the coefficient of flow rate and the coefficient of pressure can be adjusted based upon any specification or measuring condition of the associated device.

In certain embodiments, the pressure module 10 is equipped with a sleep mode feature that allows the pressure module 10 to shutdown non-essential processes during times of inactivity/no flow in order to save power. The sleep mode is configured to initiate automatically after three minutes of inactivity/no flow.

The pressure module 10 of the present invention provides a constant monitoring of a filter condition and a fluid (e.g. fuel) quality control by means of an automatic shutdown at preset thresholds. The pressure module 10 provides a means to automatically determine a differential pressure at lower flow rates and calculates a corrected differential pressure (Corr DP) up to a rated flow. The pressure module 10 includes adjustable inputs to interface with any type of flow rate measurement device and pressure transducer. The pressure module 10 includes a user interface 12 to provide ‘on the fly’ adjustments to certain parameters while operating in the field. The pressure module 10 includes a display 14 to present instant, average and maximums of differential pressure and flow information, as well as the corrected differential pressure. The pressure module 10 can also output a signal to indicate change-out of the filter or to stop the flow through the filter.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A flow differential pressure module for a transient fluid comprising:
a circuit board having a means for processing data;
a flow meter input in data communication with the circuit board to receive a flow data representing at least a flow rate of the fluid; and
a pressure sensor input in data communication with the circuit board to receive a pressure data representing at least a differential pressure of the fluid;
wherein the circuit board processes data from at least one of the flow meter and the pressure sensor to calculate a corrected differential pressure.

2. The pressure module according to claim 1, further comprising a light source in signal communication with the circuit board to be selectively energized to communicate an alert to a user.

3. The pressure module according to claim 1, further comprising a user interface in signal communication with the circuit board, the user interface having a display to provide a visual representation of at least one of the corrected differential pressure, an actual differential pressure, and a flow rate.

4. The pressure module according to claim 1, further comprising a keypad in signal communication with the circuit board to control a programming feature associated with the means for processing data.

5. The pressure module according to claim 1, wherein the circuit board communicates a warning to a user when the corrected differential pressure exceeds a threshold value.

6. The pressure module according to claim 1, further comprising a controller for adjusting a flow rate of the transient fluid, the controller in communication with the circuit board to receive a control signal from the circuit board.

7. The pressure module according to claim 6, wherein the controller receives a signal from the circuit board to modify a flow of the transient fluid when the corrected differential pressure exceeds a threshold value.

8. A monitoring system for a transient fluid comprising:
a circuit board having a means for processing data;
a flow meter in data communication with the circuit board to transmit data thereto, the data representing at least a flow rate of the fluid; and
a pressure sensor in data communication with the circuit board to transmit data thereto, the data representing at least a differential pressure of the fluid;
wherein the circuit board processes data from at least one of the flow meter and the pressure sensor to calculate a corrected differential pressure.

9. The pressure module according to claim 8, further comprising a light source in signal communication with the circuit board to be selectively energized to communicate an alert to a user.

10. The pressure module according to claim 8, further comprising a user interface in signal communication with the circuit board, the user interface having a display to provide a visual representation of at least one of the corrected differential pressure, an actual differential pressure, and a flow rate.

11. The pressure module according to claim 8, further comprising a keypad in signal communication with the circuit board to control a programming feature associated with the means for processing data.

12. The pressure module according to claim 8, wherein the circuit board communicates a warning to a user when the corrected differential pressure exceeds a threshold value.

13. The pressure module according to claim 8, further comprising a controller for adjusting a flow rate of the transient fluid, the controller in communication with the circuit board to receive a control signal from the circuit board.

14. The pressure module according to claim 13, wherein the controller receives a signal from the circuit board to modify a flow of the transient fluid when the corrected differential pressure exceeds a threshold value.

15. A method of monitoring a transient fluid, the method comprising the steps of:
receiving a flow data from a flow meter, the flow data representing at least a flow rate of the fluid;
receiving a pressure data from a pressure sensor representing at least a differential pressure of the fluid;
determining a coefficient of flow rate based upon a configuration of the flow meter;
determining a coefficient of pressure based upon a configuration of the pressure sensor; and
calculating a corrected differential pressure based upon the flow data, the pressure data, the coefficient of flow rate, and the coefficient of pressure.

16. The method according to claim 15, further comprising the step of presenting a visual representation to a user, the visual representation representing at least one of the corrected differential pressure, an actual differential pressure, and a flow rate.

17. The method according to claim 15, wherein a user can adjust at least one of the coefficient of flow and the coefficient of pressure.

18. The method according to claim 15, further comprising the step of communicating a warning to a user when the corrected differential pressure exceeds a threshold value.

19. The method according to claim 15, further comprising the step of adjusting a flow rate of the transient fluid in response to the corrected differential pressure.

20. The method according to claim 15, further comprising the step of substantially stopping a flow of the transient fluid when the corrected differential pressure exceeds a threshold value.
